(19) United States
(12) Patent Application Publication
(10) Pub. No.: US 2026/0142768 A1
(43) Pub. Date: May 21, 2026

(54) TECHNIQUES FOR DATA TRANSMISSION USING REFERENCE SIGNAL RESOURCES

(71) Applicant: Lenovo (United States) Inc., Morrisville, NC (US)

(72) Inventor: Vijay Nangia, Woodridge, IL (US)

(21) Appl. No.: 19/446,827

(22) Filed: Jan. 12, 2026

(51) Int. Cl. H04L 5/00

(52) U.S. Cl. CPC H04L 5/0044; H04L 5/0007

(57) ABSTRACT

Various aspects of the present disclosure relate to techniques for data transmission using reference signal resources. A user equipment is configured to receive a downlink signal comprising reference-signal resources associated with a reference signal sequence, process, on at least a portion of the reference-signal resources, at least one information-bearing symbol that is spread using the reference signal sequence and an orthogonal cover code, and recover data based on the at least one information-bearing symbol associated with the reference signal sequence and the orthogonal cover code.

### TECHNICAL FIELD

The present disclosure relates to wireless communications, and more specifically to techniques for data transmission using reference signal resources.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE) and methods of the present disclosure each have several innovative aspects, no single one of which is solely responsible for the desirable features disclosed herein.

A UE for wireless communication is described. The UE may be configured to, capable of, or operable to receive a downlink signal comprising reference-signal resources associated with a reference signal sequence, process, on at least a portion of the reference-signal resources, at least one information-bearing symbol that is spread using the reference signal sequence and an orthogonal cover code, and recover data based on the at least one information-bearing symbol associated with the reference signal sequence and the orthogonal cover code.

A processor for wireless communication is described. The processor may be configured to, capable of, or operable to receive a downlink signal comprising reference-signal resources associated with a reference signal sequence, process, on at least a portion of the reference-signal resources, at least one information-bearing symbol that is spread using the reference signal sequence and an orthogonal cover code, and recover data based on the at least one information-bearing symbol associated with the reference signal sequence and the orthogonal cover code.

A method for wireless communication performed by a UE is described. The method may be configured to, capable of, or operable to receive a downlink signal comprising reference-signal resources associated with a reference signal sequence, process, on at least a portion of the reference-signal resources, at least one information-bearing symbol that is spread using the reference signal sequence and an orthogonal cover code, and recover data based on the at least one information-bearing symbol associated with the reference signal sequence and the orthogonal cover code.

An NE for wireless communication is described. The NE may be configured to, capable of, or operable to generate a downlink signal including reference-signal resources associated with a reference signal sequence, map information-bearing symbols onto at least a portion of the reference-signal resources by spreading the information-bearing symbols using the reference signal sequence and an orthogonal cover code, and transmit the downlink signal to a UE.

A processor for wireless communication is described. The processor may be configured to, capable of, or operable to generate a downlink signal including reference-signal resources associated with a reference signal sequence, map information-bearing symbols onto at least a portion of the reference-signal resources by spreading the information-bearing symbols using the reference signal sequence and an orthogonal cover code, and transmit the downlink signal to a UE.

A method for wireless communication performed by a NE is described. The method may be configured to, capable of, or operable to generate a downlink signal including reference-signal resources associated with a reference signal sequence, map information-bearing symbols onto at least a portion of the reference-signal resources by spreading the information-bearing symbols using the reference signal sequence and an orthogonal cover code, and transmit the downlink signal to a UE.

### BRIEF DESCRIPTION OF THE DRAWINGS

FIG. 1 illustrates an example of a wireless communications system in accordance with aspects of the present disclosure.

FIG. 2 illustrates an example resource block in accordance with aspects of the present disclosure.

FIG. 3 illustrates an example resource block in accordance with aspects of the present disclosure.

FIG. 4 illustrates an example resource block in accordance with aspects of the present disclosure.

FIG. 5 illustrates an example resource block in accordance with aspects of the present disclosure.

FIG. 6 illustrates an example resource block in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

Modern wireless communication systems employ reference signals to enable functions such as channel estimation, demodulation, and synchronization. These reference signals are typically mapped to predefined reference-signal resources within a time-frequency grid and are not used to convey data, e.g., user data. As system bandwidths, antenna counts, and transmission layers continue to increase, the number of reference-signal resources allocated within a transmission can become significant, reducing the resources available for data transmission and negatively impacting spectral efficiency.

In next-generation wireless communication systems, including systems beyond 5G, support for larger antenna arrays, wider bandwidths, and higher data rates has led to increased use of multi-layer transmissions. Such transmissions typically rely on multiple reference-signal ports, resulting in increased reference-signal overhead for channel estimation and decoding, for example, through the use of multi-port demodulation reference signals. However, existing specifications generally prohibit data transmission on reference-signal resources, including reference-signal resources associated with the same user equipment or with co-scheduled UEs.

In many deployment scenarios, such as fixed or slowly varying channel conditions, the density of reference signals required to achieve reliable channel estimation may be lower than the reference-signal density configured for a transmission. In addition, in multi-user or multi-layer transmissions, reference-signal resources may be reserved for multiple users or layers but remain partially unused or underutilized. Conventional techniques do not provide an efficient mechanism to reclaim such reference-signal resources for data transmission while preserving the orthogonality and signal processing benefits associated with reference signals.

Accordingly, techniques are described for transmitting data using reference-signal resources. In the disclosed approach, information-bearing symbols are mapped onto at least a portion of reference-signal resources by spreading the information-bearing symbols using a reference signal sequence and an orthogonal cover code. By applying the reference signal sequence and orthogonal cover code, the information-bearing symbols remain separable from reference symbols and from other transmissions that may share the same reference-signal resources.

The disclosed techniques enable reference-signal resources to be reused for data transmission without degrading channel estimation performance or interfering with co-scheduled transmissions. As a result, spectral efficiency may be improved while maintaining compatibility with existing reference-signal structures and receiver processing. The techniques are applicable to a variety of transmission scenarios, including single-user and multi-user transmissions, multiple-input multiple-output (MIMO) systems, and deployments with slowly varying channel conditions.

Aspects of the present disclosure are described in the context of a wireless communications system. Note that one or more aspects from different solutions may be combined.

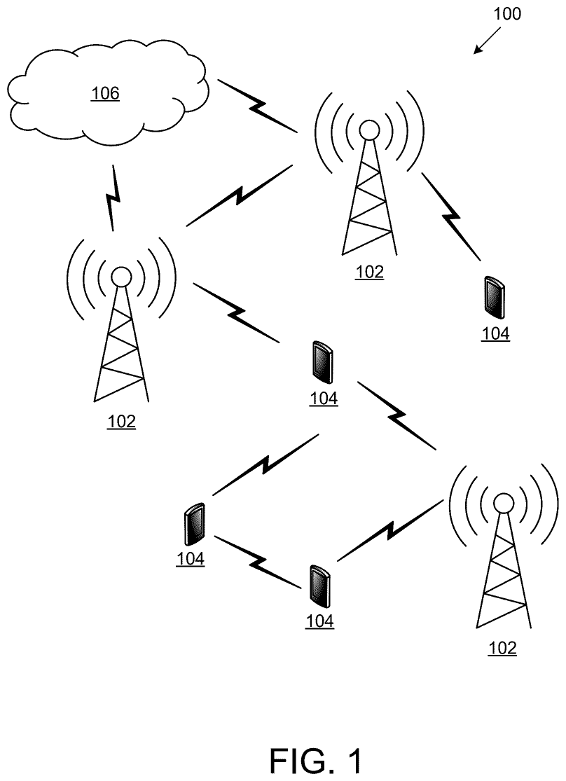

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHz), FR3 (7.125 GHz-24.25 GHZ), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ-2), which includes 60 kHz subcarrier spacing; and a fourth numerology (e.g., μ=3), which includes 120 kHz subcarrier spacing.

In the wireless communications system 100 illustrated in FIG. 1, the NEs 102 and the UEs 104 exchange signals over shared time and frequency resources that include both data resources and reference-signal resources. Reference signals may be transmitted by an NE 102 to enable functions such as channel estimation, demodulation, and interference management at a UE 104. Conventionally, the reference-signal resources allocated for such reference signals are not used to convey data, such as user data, which may result in underutilization of available resources, particularly in scenarios with slowly varying channels or conservative reference-signal configurations.

As used herein, an information-bearing signal or information-bearing symbol refers to a signal or symbol that conveys data such as user data, payload data, or data bits associated with a transport block or codeword and is distinct from reference signals transmitted primarily for channel estimation, synchronization, or tracking purposes. An information-bearing symbol may include a modulation symbol mapped to one or more resource elements and may, in some examples, be spread using a reference signal sequence and one or more orthogonal cover codes.

As used herein, a reference signal resource or reference signal resource element refers to a time-frequency or time-frequency-code resource that is configured or conventionally reserved for transmission of a reference signal, such as a demodulation reference signal (DMRS), channel state information reference signal (CSI-RS), or sounding reference signal (SRS), regardless of whether a reference signal is actually transmitted on the resource.

As used herein, an orthogonal cover code refers to a sequence, code, or set of coefficients applied in a frequency domain, a time domain, or both, to provide orthogonality between signals multiplexed on the same resource elements, including but not limited to Walsh, Hadamard, or other orthogonal sequences.

As used herein, an antenna port refers to a logical transmission or reception entity associated with a radio channel, and may correspond to a physical antenna, a group of physical antennas, or a beamformed combination of antennas, where signals transmitted or received on the antenna port are associated with a common channel response.

As used herein, co-scheduled nodes or co-scheduled UEs refer to two or more nodes or UEs that are scheduled to transmit or receive signals using overlapping time-frequency resources, regardless of whether the nodes or UEs are associated with the same or different antenna ports, layers, or precoders.

As used herein, mapping a signal or symbol to a resource element includes allocating, assigning, or otherwise associating the signal or symbol with the resource element for transmission or reception, and may include spreading, precoding, scaling, or other signal processing operations.

As used herein, inferring a channel includes deriving, estimating, extrapolating, interpolating, or reusing channel information based on one or more reference signals, including across time, frequency, antenna ports, or layers.

As described herein, the wireless communications system 100 supports techniques for data transmission using reference-signal resources. In some implementations, an NE 102 may generate a downlink signal in which information-bearing symbols are mapped to at least a portion of reference-signal resources by spreading the information-bearing symbols using a reference signal sequence and an orthogonal cover code. The downlink signal may be transmitted to a UE 104 using existing frame structures, numerologies, and resource grids supported by the wireless communications system 100, including those described above with respect to symbols, slots, subframes, and frames.

In some examples, a downlink signal transmitted by an NE 102 may comprise one or more information-bearing signals and may further comprise, or otherwise indicate, reference-signal resources on which the information-bearing signals are mapped. As used herein, a downlink signal comprising reference-signal resources includes not only a downlink waveform that physically includes symbols transmitted on such resources, but also a downlink transmission that identifies, configures, schedules, or otherwise points to the reference-signal resources for reception and processing by a UE 104.

In some examples, the downlink signal may include information-bearing symbols transmitted on reference-signal resources. In other examples, the downlink signal may include control information, configuration information, or scheduling information that indicates a set of reference-signal resources, orthogonal cover codes, reference signal sequences, antenna ports, layers, power relationships, or combinations thereof, that are to be used by the UE 104 to receive and process information-bearing symbols mapped to reference-signal resources.

Such indication of reference-signal resources may be provided via one or more control channels, higher-layer signaling, downlink control information (DCI), or implicit association with a configured reference-signal pattern. In these examples, the downlink signal may be interpreted broadly as pointing to, identifying, or defining the reference-signal resources used for conveying information-bearing symbols, regardless of whether the downlink signal physically includes all symbols transmitted on those resources.

Accordingly, reception of a downlink signal comprising reference-signal resources includes reception of a downlink transmission that either carries information-bearing symbols on the reference-signal resources or provides sufficient information for the UE 104 to determine the reference-signal resources on which the information-bearing symbols are transmitted and to process those symbols using a reference signal sequence and one or more orthogonal cover codes.

A UE 104 receiving the downlink signal may process the reference-signal resources to separate reference symbols and information-bearing symbols based on the reference signal sequence and the orthogonal cover code. In this manner, the UE 104 may recover data, e.g., user data conveyed on reference-signal resources while still performing channel estimation or other reference-signal-based processing. The disclosed techniques may be applied in a variety of deployment scenarios supported by the wireless communications system 100, including single-user transmissions, multi-user transmissions, and MIMO transmissions, and across different frequency ranges and numerologies.

By enabling reference-signal resources to carry information-bearing symbols in addition to or instead of conventional reference symbols, the wireless communications system 100 may improve spectral efficiency while maintaining compatibility with existing reference-signal structures and receiver processing. Accordingly, the techniques described herein provide a flexible mechanism for enhancing data transmission efficiency in wireless communication systems.

In the wireless communications system 100 illustrated in FIG. 1, NEs 102 transmit reference signals to UEs 104 to support functions such as channel estimation, coherent demodulation, phase tracking, and spatial processing for data transmissions. In some radio access technologies, such as NR, reference signals associated with physical data channels may include demodulation reference signals (DMRS) and phase-tracking reference signals (PT-RS). Such reference signals are typically mapped to predefined reference-signal resources within a time-frequency resource grid associated with a physical data channel, such as a physical downlink shared channel (PDSCH), and are conventionally reserved for reference signaling rather than data transmission.

For reception of DMRS associated with a PDSCH, a UE 104 may infer large-scale channel properties based on quasi co-location (QCL) relationships with other reference signals transmitted by an NE 102. For example, QCL Type A properties, including Doppler shift, Doppler spread, average delay, and delay spread, associated with a DMRS may be inferred from a tracking reference signal (TRS). In turn, QCL Type C properties, such as Doppler shift and average delay, associated with a periodic TRS may be inferred from a synchronization signal block (SSB). In some configurations, a channel state information reference signal (CSI-RS) may additionally or alternatively serve as a QCL reference, for example to provide tracking over a larger bandwidth than an SSB.

A DMRS sequence may be generated using a pseudo-random sequence generator initialized based on one or more parameters such as an OFDM symbol index, a slot index within a frame, a scrambling identifier indicated via control signaling, a physical cell identifier, or a code division multiplexing (CDM) group index. In downlink transmissions, DMRS symbols are typically subject to the same precoding as the associated PDSCH data symbols, enabling coherent detection at the UE 104.

Multiple time-domain mapping structures for DMRS may be supported. In one mapping structure, a first DMRS symbol may be positioned at a predefined symbol location within a slot relative to a slot boundary, independent of where data symbols are scheduled within the slot. In another mapping structure, the first DMRS symbol may be positioned relative to the start of a data allocation, such that the DMRS location depends on where data symbols are mapped. The mapping structure for a PDSCH transmission may be dynamically indicated by the NE 102 to the UE 104, for example via downlink control information.

DMRS may further be configured according to different frequency-domain structures that determine how reference signals are multiplexed across subcarriers and antenna ports. In some implementations, a first DMRS type may support a first maximum number of orthogonal reference signals using code division multiplexing in the frequency domain, while a second DMRS type may support a larger number of orthogonal reference signals using additional frequency-domain resources. For example, different antenna ports may be mapped to different subsets of subcarriers within a resource block and separated using orthogonal cover codes within a CDM group. Multiple CDM groups may be defined within a resource block, each occupying a subset of subcarriers. Depending on configuration, DMRS may be transmitted using one or more symbols, and additional DMRS symbols may be distributed within a scheduled PDSCH duration. Within a scheduled PDSCH allocation, a UE 104 may expect an initial set of front-loaded DMRS symbols and, in some cases, additional DMRS symbols, with an upper bound on the number of DMRS symbols defined by configuration.

In some implementations, DMRS antenna ports associated with the same CDM group may be assumed to be quasi co-located with respect to one or more large-scale channel properties. Accordingly, the UE 104 may perform joint channel estimation for DMRS ports that are code-division multiplexed using the same long-term channel statistics, without separately estimating such properties for each port. Such assumptions may simplify receiver processing and reduce estimation overhead.

In some examples, DMRS resources may be intentionally omitted on a subset of RBs and/or slots as part of a DMRS reduction strategy, and the disclosed techniques enable reuse of such DMRS resources for data transmission without degrading channel estimation performance. Further, in uplink transmissions, similar techniques may be applied using uplink reference signals such as DMRS or sounding reference signal (SRS), where information-bearing symbols are spread using an uplink reference signal sequence and orthogonal cover codes and mapped to uplink reference-signal resources.

In the wireless communications system 100 shown in FIG. 1, an antenna port may be defined as a logical entity such that the channel over which a symbol transmitted on the antenna port is conveyed can be inferred from the channel over which another symbol transmitted on the same antenna port is conveyed. Two antenna ports may be considered quasi co-located if large-scale channel properties associated with one antenna port can be inferred from those associated with another antenna port. Large-scale properties may include one or more of Doppler shift, Doppler spread, delay spread, average delay, average gain, and spatial reception parameters. Different QCL types may be defined to indicate which subsets of such properties are assumed to be common between reference signals, and certain QCL types may be applicable across a wide range of carrier frequencies, while others may be applicable primarily at higher carrier frequencies where directional transmission and reception are employed.

Antenna elements of a UE 104 or an NE 102 may be organized into one or more antenna panels. An antenna panel may include a physical or logical array of antenna elements or antenna ports that share at least a portion of a radio frequency (RF) chain, such as an in-phase/quadrature modulator, an analog-to-digital converter, a local oscillator, or a phase shift network. Antenna panels may operate at various carrier frequencies, including frequencies below 6 GHz, frequencies between approximately 7 GHz and 15 GHz, and frequencies above 24 GHz. Beamforming weights or other spatial parameters may be applied across antenna elements of an antenna panel to generate a radiation pattern or beam that may be steered toward one or more spatial directions.

An antenna panel may be mapped to one or more logical antenna ports. In some implementations, a single physical antenna element may correspond directly to a logical antenna port. In other implementations, a set or subset of physical antenna elements, antenna arrays, or antenna sub-arrays may be mapped to one or more logical antenna ports through application of complex weighting, cyclic delay diversity, or other antenna virtualization techniques. The mapping between physical antenna elements and logical antenna ports may be implementation-specific and may be transparent to other devices in the wireless communications system 100.

Communicating using antenna elements or antenna ports that are active for radiating energy may involve biasing or powering on associated RF chains, resulting in current drain or power consumption in a device. An antenna element or antenna port may be considered active for radiating energy when it is coupled to a transmitter, a receiver, or a transceiver to perform transmission and/or reception functions. Activating subsets of antenna elements within an antenna panel may enable a device to generate radiation patterns or beams while managing power consumption.

A UE 104 may support one or more antenna panels, each of which may have one or more operational roles, such as independently controlling transmission beam direction, transmission power, or transmission timing. In some implementations, antenna panels may be transparent to the NE 102, such that the NE 102 does not explicitly configure the internal mapping between physical antenna elements and logical antenna ports of the UE 104. In some cases, the NE 102 may assume that such mappings remain unchanged for a period of time, for example until updated capability information is received from the UE 104.

Capability information associated with antenna panels may be reported by a UE 104 to an NE 102 and may include, for example, a number of supported antenna panels, beamforming capabilities, duplexing capabilities, or a number of simultaneous transmissions or receptions supported across panels. In some implementations, a UE 104 may support transmission or reception using one beam per antenna panel, while in other implementations multiple beams per antenna panel may be supported. With multiple antenna panels, a UE 104 may support simultaneous transmissions or receptions in multiple spatial directions.

In some implementations, transmission configuration indication (TCI) states and spatial relation information may be used to indicate quasi co-location relationships and spatial relationships between a target transmission and one or more source reference signals. A TCI state may identify reference signals used as QCL sources and the QCL properties that may be inferred from those reference signals. Separate downlink and uplink TCI states may be configured, or a joint downlink/uplink TCI state may be used to indicate a common source reference signal for both downlink reception and uplink transmission. Spatial relation information may indicate that a UE 104 is to transmit or receive a signal using a spatial filter associated with a reference signal, and multiple TCI states or spatial relations may be used to support simultaneous transmissions or receptions using multiple antenna panels or beams.

As described above, in wireless communication systems such as the system 100 illustrated in FIG. 1, reference signals, antenna ports, and antenna panels are conventionally configured and operated according to predefined mapping structures, orthogonalization mechanisms, and quasi co-location assumptions to support channel estimation, demodulation, and spatial processing. The techniques described herein build upon such conventional configurations to enable improved utilization of reference-signal resources.

Different implementation examples are described below. It should be understood that features described with respect to one implementation example may be combined with features of one or more other implementation examples, unless explicitly stated otherwise. Although certain examples are described in the context of a UE or a node receiving data (e.g., downlink or uplink reception), the described techniques are also applicable to a UE or a node transmitting data in the uplink or downlink. Further, while the following description refers to DMRS for clarity, the disclosed techniques are not limited to DMRS and may be applied to other types of reference signals (RS), such as CSI-RS, SRS, or combinations of different RS types.

In some examples, an RS configuration associated with data transmission or reception on a physical channel, such as a PDSCH, physical downlink control channel (PDCCH), physical uplink shared channel (PUSCH), or physical uplink control channel (PUCCH), may correspond to RS resource elements (REs) occupying a subset of time-frequency-code resources within a portion of resource blocks (RBs) associated with the data. For example, RS REs may be present in only a fraction of the RBs associated with the data transmission, such as every other RB.

In some examples, an RS configuration associated with data may correspond to RS REs occupying a subset of time-frequency-code resources within a portion of slots associated with the data. For example, RS REs may be present in every other slot. In slots that are not associated with RS, a node may reuse channel-related information derived from a most recent RS transmission associated with the same antenna ports. For example, a node may reuse an antenna port indication or a number-of-layers parameter associated with a prior transmission or reception occasion in which RS were present.

In some examples, at least a first portion of data comprising a first modulation symbol may be communicated (e.g., transmitted or received) on a first set of (REs) associated with a first antenna port. The first set of REs may correspond to physical resources that are conventionally usable for DMRS transmission. The first modulation symbol d₁(n) may be mapped to the first set of REs by spreading the first modulation symbol using a RS sequence r(·), and at least one orthogonal cover code, such as a frequency-domain orthogonal cover code w_{f}(k), a time-domain orthogonal cover code wₜ(l), or a combination thereof. At least a second portion of the data comprising a second modulation symbol d₂(n) may be communicated on a second set of resource elements without spreading using an RS sequence and may be associated with a second antenna port. In some examples, the second antenna port may be the same as the first antenna port.

In some examples, the first complex-valued modulation symbol d₁(n) may be scaled by a factor β₁ to conform to a first transmission power, for example a transmission power associated with DMRS REs or to maintain power consistency across OFDM symbols. The scaled first modulation symbol may be spread using an RS sequence, such as a pseudo-random sequence, and further multiplied by at least one orthogonal cover code. For example, the orthogonal cover code may include a frequency-domain orthogonal cover code or sequence w_{f}(k), such as a length-4 orthogonal cover code or Hadamard sequence, and/or a time-domain orthogonal cover code or sequence wₜ(l), such as a length-2 orthogonal cover code or Hadamard sequence used in a double-symbol DMRS configuration. In some examples, the first modulation symbol may be multiplied by the RS sequence and the at least one orthogonal cover code to generate an RS-sequence-spread modulation symbol. The RS-sequence-spread first complex-valued modulation symbol may be precoded using a precoder (e.g., a precoding vector) and mapped to resource elements (k, l)_{p,μ} associated with antenna port p.

$$\begin{matrix}{y}_{k , l}^{( p )} = {β}_{1} {d}_{1} ( n ) {w}_{f} ( {k}^{′} ) {w}_{t} ( {l}^{′} ) r ( 4 n + {k}^{′} ) \\ k = 12 n + {k}^{′} + Δ \\ {k}^{′} = 0 , 1 , 2 , 3 \\ l = \overline{l} + {l}^{′} \\ n = 0 , 1 , …\end{matrix}$$

In some examples, exemplary values of W_{f}(k′), wₜ(l′), and A for a first DMRS configuration type are illustrated in Table 1, where I indicates DMRS OFDM symbol positions. In some examples, l′=0 corresponds to a single-symbol DMRS configuration in which a time-domain orthogonal code is not used, and l′=0.1 corresponds to a double-symbol DMRS configuration in which a time-domain orthogonal code is used. In some examples, each CDM group may occupy a set of adjacent REs in the frequency domain, for example four adjacent REs, and may span one or two OFDM symbols depending on whether a single-symbol DMRS configuration or a double-symbol DMRS configuration is employed.

TABLE 1
Parameters for a first DM-RS configuration type.

| Index j | CDM group λ | Δ | [w_{f}(0) . . . w_{f}(3)] | [wₜ(0) wₜ(1)] |
|---|---|---|---|---|
| 0 | 0 | 0 | [+1 +1 +1 +1] | [+1 +1] |
| 1 | 0 | 0 | [+1 −1 +1 −1] | [+1 +1] |
| 2 | 0 | 0 | [+1 +1 −1 −1] | [+1 +1] |
| 3 | 0 | 0 | [+1 −1 −1 +1] | [+1 +1] |
| 4 | 0 | 0 | [+1 +1 +1 +1] | [+1 −1] |
| 5 | 0 | 0 | [+1 −1 +1 −1] | [+1 −1] |
| 6 | 0 | 0 | [+1 +1 −1 −1] | [+1 −1] |
| 7 | 0 | 0 | [+1 −1 −1 +1] | [+1 −1] |
| 8 | 1 | 4 | [+1 +1 +1 +1] | [+1 +1] |
| 9 | 1 | 4 | [+1 −1 +1 −1] | [+1 +1] |
| 10 | 1 | 4 | [+1 +1 −1 −1] | [+1 +1] |
| 11 | 1 | 4 | [+1 −1 −1 +1] | [+1 +1] |
| 12 | 1 | 4 | [+1 +1 +1 +1] | [+1 −1] |
| 13 | 1 | 4 | [+1 −1 +1 −1] | [+1 −1] |
| 14 | 1 | 4 | [+1 +1 −1 −1] | [+1 −1] |
| 15 | 1 | 4 | [+1 −1 −1 +1] | [+1 −1] |
| 16 | 2 | 8 | [+1 +1 +1 +1] | [+1 +1] |
| 17 | 2 | 8 | [+1 −1 +1 −1] | [+1 +1] |
| 18 | 2 | 8 | [+1 +1 −1 −1] | [+1 +1] |
| 19 | 2 | 8 | [+1 −1 −1 +1] | [+1 +1] |
| 20 | 2 | 8 | [+1 +1 +1 +1] | [+1 −1] |
| 21 | 2 | 8 | [+1 −1 +1 −1] | [+1 −1] |
| 22 | 2 | 8 | [+1 +1 −1 −1] | [+1 −1] |
| 23 | 2 | 8 | [+1 −1 −1 +1] | [+1 −1] |

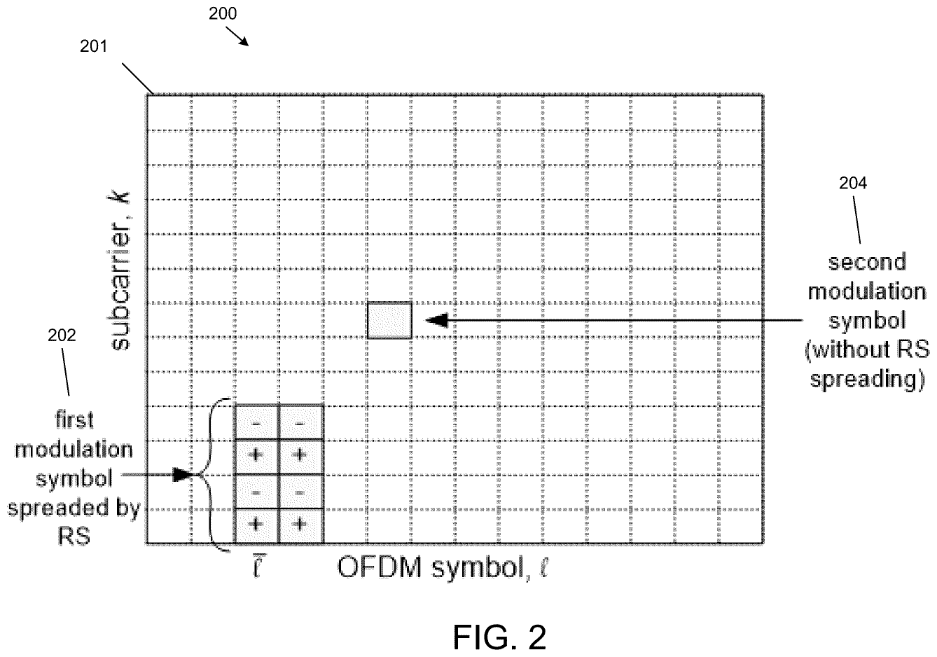

FIG. 2 illustrates an example resource block in accordance with aspects of the present disclosure. In one example as shown in FIG. 2, within an RB 201, a first complex-valued modulation symbol 202 uses index j=1 corresponding to CDM group λ=0, frequency-domain orthogonal code w_{f}(k)=[+1−1+1−1], and time-domain orthogonal code wₜ(l)=[+1+1] for double-symbol DM-RS and on antenna port p=1000+j=1001.

In some examples, a second modulation symbol 204 may be a complex-valued modulation symbol (d₂(n)) that is not spread using an RS sequence. The second modulation symbol 204 may be scaled to conform to a second transmission power associated with data REs and mapped to REs (k, l)ₚ of one or more resource blocks assigned for transmission. The mapped REs may satisfy one or more conditions, such as not being used for transmission of RS-spread modulation symbols, not being associated with DMRS or other RS transmissions, and not being reserved for DMRS intended for other co-scheduled UEs, if present or indicated.

In some examples, the sequence r (n) is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where c(i) is a pseudo-random sequence such as a length-31 Gold sequence. The pseudo-random sequence generator may be initialized with Cᵢₙᵢₜ which may be a function of the OFDM symbol number l, slot number within a frame

$${n}_{s , f}^{μ}$$

is the slot number, and higher-layer scrambling ID parameters.

In some examples, at least a first portion of the data comprising a first modulation symbol d₁(n) may correspond to a modulation symbol of a first transmission layer associated with a first precoder (e.g., a first precoding vector). At least a second portion of the data comprising a second modulation symbol d₂(n) may correspond to a modulation symbol of a second transmission layer associated with a second precoder (e.g., a second precoding vector). The RS-sequence-spread first complex-valued modulation symbol

$${y}_{k , l}^{( p )}$$

may be precoded using the first precoder and mapped to a first set of resource elements on a first antenna port. The second complex-valued modulation symbol d₂(n) may be precoded using the second precoder and mapped to a second set of resource elements on a second antenna port.

In some examples, the first transmission layer and the second transmission layer may be the same layer, the first precoder and the second precoder may be the same precoder, and the first antenna port and the second antenna port may be the same antenna port.

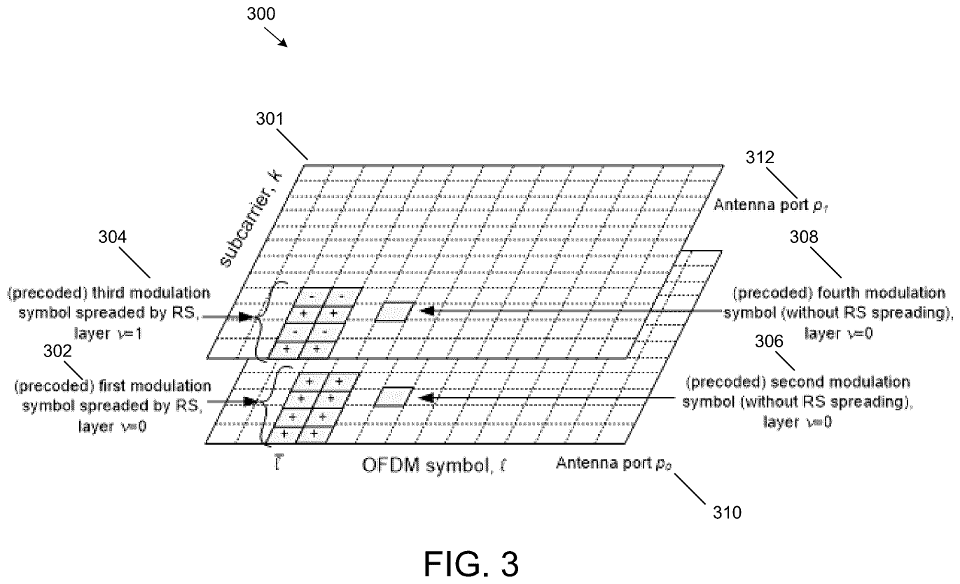

FIG. 3 illustrates an example resource block in accordance with aspects of the present disclosure. In the example illustrated in FIG. 3, within an RB 301, at least a first portion of the data comprising a first modulation symbol 302 and a third modulation symbol 304 may be mapped to the same set of time-frequency resource elements, where each of the first and third modulation symbols 302, 304 is spread using an RS sequence and at least one orthogonal code in a frequency domain and/or a time domain. The first and third modulation symbols 302, 304 may be associated with a first set of transmission layers having a first number of layers. At least a second portion of the data comprising a second modulation symbol 306 and a fourth modulation symbol 308 may be mapped to resource elements without RS spreading and may be associated with a second set of transmission layers having a second number of layers. In some examples, the second set of layers having the second number of layers may be the same as the first set of layers having the first number of layers.

In the example shown in FIG. 3, the first complex-valued modulation symbol 302 may be associated with index j=0 corresponding to CDM group λ=0, a frequency-domain orthogonal code w_{f}(k)=[+1+1+1+1], and a time-domain orthogonal code wₜ(1)=[+1+1] for a double-symbol DMRS configuration, and may be transmitted on antenna port p₀ 310 associated with transmission layer v=0.

The third complex-valued modulation symbol 304 may be associated with index j=1 corresponding to CDM group λ=1, a frequency-domain orthogonal code W_{f}(k)=[+1-1+1-1], and a time-domain orthogonal code wₜ(l)=[+1+1] for the double-symbol DMRS configuration, and may be transmitted on antenna port p₁ 312 associated with transmission layer v=1, using the same set of time-frequency resource elements as the first modulation symbol 302. In this example, the frequency-domain orthogonal codes used for the first modulation symbol 302 and the third modulation symbol 304 are orthogonal to one another.

The second modulation symbol 306, which is not spread using an RS sequence, may be associated with transmission layer v=0 and communicated on antenna port p₀ 310. The fourth modulation symbol 308, which is also not spread using an RS sequence, may be associated with transmission layer v=1 and communicated on antenna port p₁ 312, on the same time-frequency resources as the first and third modulation symbols 302, 304.

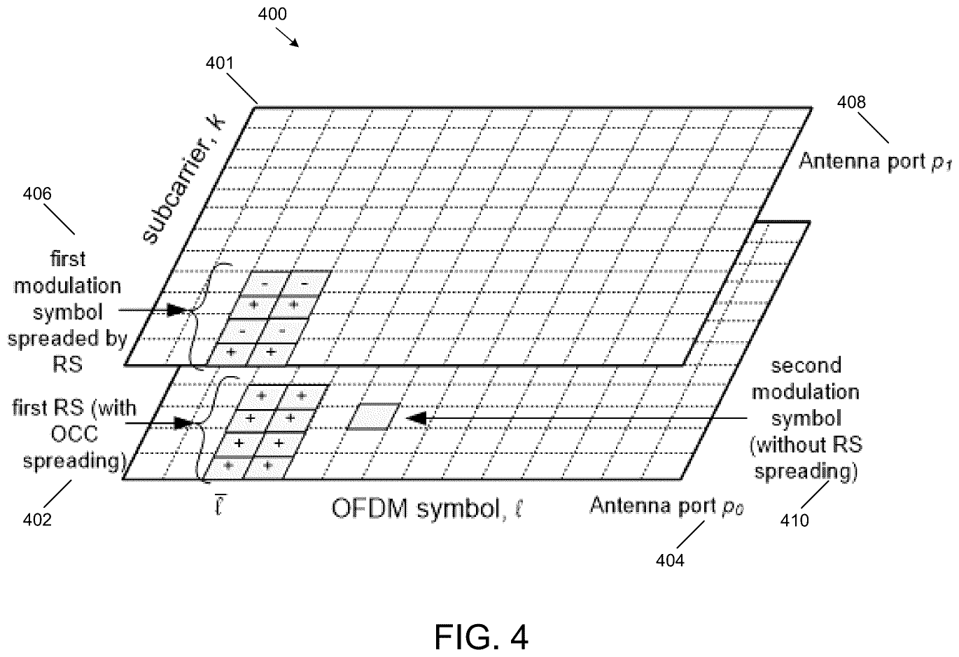

FIG. 4 illustrates an example resource block in accordance with aspects of the present disclosure. In some examples, as illustrated in FIG. 4, for a UE, within a resource block 401, a first RS 402 comprising a first RS sequence r(·) may be communicated (e.g., transmitted or received) on a first set of REs associated with a first antenna port p₀ 404. The first RS 402 may be mapped to the first set of REs by spreading using at least one orthogonal cover code, such as a first frequency-domain orthogonal code w_{f}(k), a first time-domain orthogonal code wₜ(l), or a combination thereof.

At least a first portion of data comprising a first modulation symbol 406 may be communicated on the same first set of REs, which correspond to physical resources conventionally used for RS transmission, and may be associated with a second antenna port p₁ 408. The first modulation symbol 406 d₁(n) may be mapped to the first set of REs by spreading the first modulation symbol 406 using the first RS sequence r(·) and at least one orthogonal cover code, such as a second frequency-domain orthogonal code and/or a second time-domain orthogonal code, such that the first modulation symbol 406 is orthogonally multiplexed with the first RS.

At least a second portion of data comprising a second modulation symbol 410 d₂(n) may be communicated on a second set of resource elements without spreading using an RS sequence and may be associated with the first antenna port p₀ 404. In some examples, the first RS 402 may be associated with at least one of the first modulation symbol 406 and the second modulation symbol 410, for example such that the first RS 402 is used for demodulation of at least one of the first modulation symbol 406 and the second modulation symbol 410.

In some examples, communication on the first antenna port p₀ 404 may be associated with a first precoder (e.g., a first precoding vector), and communication on the second antenna port p₁ 408 may be associated with a second precoder (e.g., a second precoding vector). In other examples, a same precoder may be used for both the first RS 402 and the first modulation symbol 406. In some examples, the second antenna port p₁ 408 may be the same as the first antenna port p₀ 404.

In some examples, modulation symbols of the data may not be mapped to the second antenna port p₁ 408 except for modulation symbols, such as the first modulation symbol 406, that are spread using the RS sequence and orthogonally multiplexed with the RS.

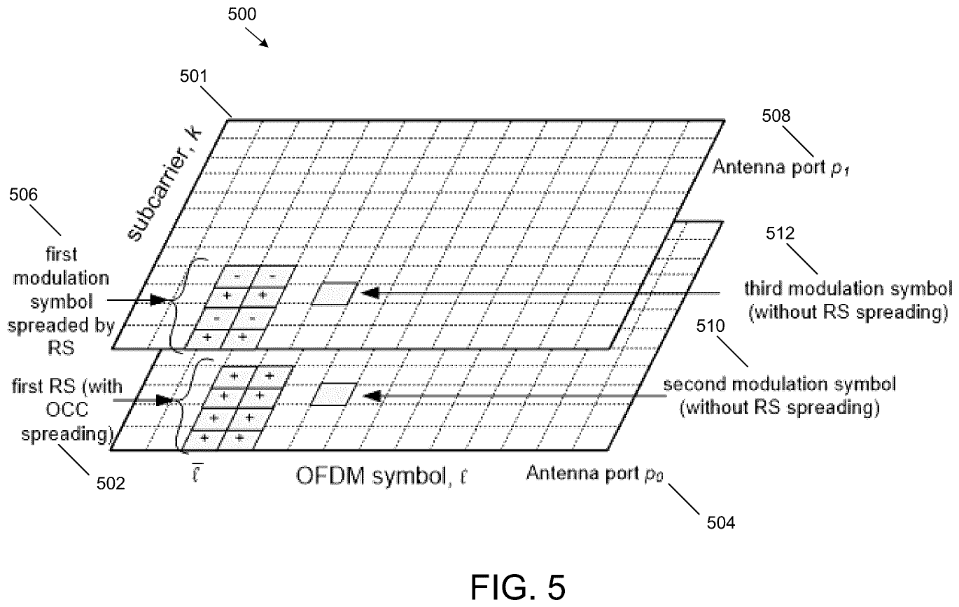

FIG. 5 illustrates an example resource block in accordance with aspects of the present disclosure. In some examples, as illustrated in FIG. 5, for a UE, within a resource block 501, a first RS 502 comprising a first RS sequence r(·) may be communicated (e.g., transmitted or received) on a first set of REs associated with a first antenna port p₀ 504. The first RS 502 may be mapped to the first set of REs by spreading using at least one orthogonal cover code, such as a first frequency-domain orthogonal code w_{f}(k), a first time-domain orthogonal code wₜ(l), or a combination thereof.

At least a first portion of data comprising a first modulation symbol 506 may be communicated on the same first set of REs, which correspond to physical resources conventionally used for RS transmission, and may be associated with a second antenna port p₁ 508. The first modulation symbol 506 d₁(n) may be mapped to the first set of REs by spreading the first modulation symbol using the first RS sequence r(·) and at least one orthogonal cover code, such as a second frequency-domain orthogonal code and/or a second time-domain orthogonal code, such that the first modulation symbol 506 is orthogonally multiplexed with the first RS 502.

At least a second portion of data comprising a second modulation symbol 510 d₂(n) may be communicated on a second set of resource elements without spreading using an RS sequence and may be associated with the first antenna port p₀ 504. At least a third portion of data comprising a third modulation symbol 512 d₃(n) may be communicated on the second set of resource elements without spreading using an RS sequence and may be associated with the second antenna port p₁ 508.

In some examples, communication on the first antenna port p₀ 504 may be associated with a first precoder (e.g., a first precoding vector), and communication on the second antenna port p₁ 508 may be associated with a second precoder (e.g., a second precoding vector). In some examples, on a first resource block, the first RS 502 may be mapped and associated with the first antenna port p₀ 504 and the first modulation symbol 506 may be mapped and associated with the second antenna port p₁ 508, and on a second resource block, the first RS 502 may be mapped and associated with the second antenna port p₁ 508 and the first modulation symbol 506 may be mapped and associated with the first antenna port p₀ 504. Such alternation of RS mapping across resource blocks may enable channel estimation for both the first antenna port p₀ 504 and the second antenna port p₁ 508.

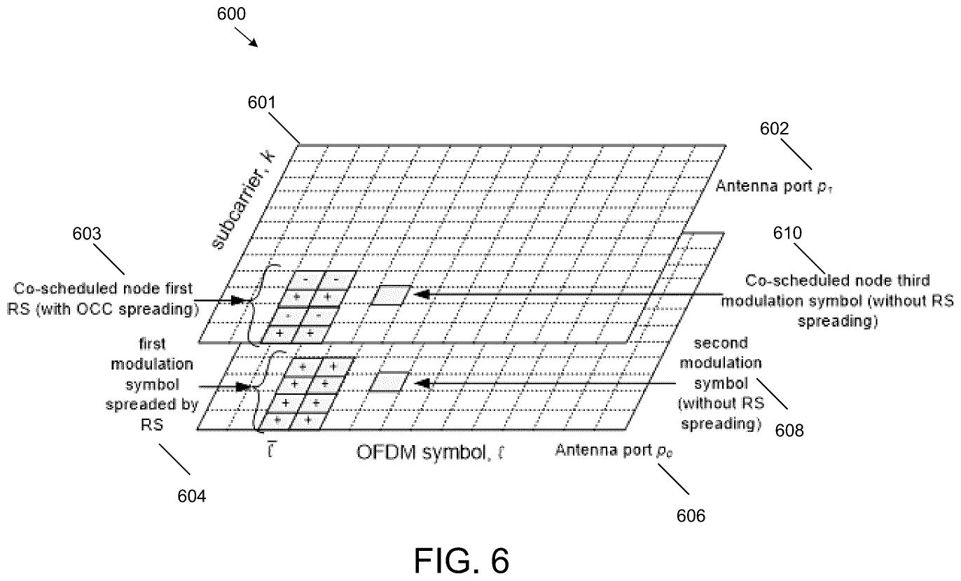

FIG. 6 illustrates an example resource block in accordance with aspects of the present disclosure. In some examples, as illustrated in FIG. 6, for a co-scheduled UE (also referred to as a second UE), within a resource block 601, a first RS 603 comprising a first RS sequence r(·) may be communicated (e.g., transmitted or received) on a first set of REs associated with a second antenna port p₁ 602. The first RS 603 may be mapped to the first set of REs by spreading using at least one orthogonal cover code, such as a first frequency-domain orthogonal code w_{f}(k), a first time-domain orthogonal code wₜ(l), or a combination thereof.

For a first UE, at least a first portion of data comprising a first modulation symbol 604 may be communicated on the same first set of REs, which correspond to physical resources conventionally used for RS transmission, and may be associated with a first antenna port p₀ 606. The first modulation symbol 604 d₁(n) may be mapped to the first set of REs by spreading the first modulation symbol 604 using the first RS sequence r(·) and at least one orthogonal cover code, such as a second frequency-domain orthogonal code and/or a second time-domain orthogonal code, such that the first modulation symbol 604 is orthogonally multiplexed with the first RS 603.

For the first UE, at least a second portion of data comprising a second modulation symbol 608 d₂(n) may be communicated on a second set of resource elements without spreading using an RS sequence and may be associated with the first antenna port p₀ 606. For the co-scheduled UE, at least a second portion of data comprising a third modulation symbol 610 d₃(n) may be communicated on the second set of resource elements without spreading using an RS sequence and may be associated with the second antenna port p₁ 602. In some examples, communication on the first antenna port p₀ 606 may be associated with a first precoder (e.g., a first precoding vector), and communication on the second antenna port p₁ 602 may be associated with a second precoder (e.g., a second precoding vector).

In some examples, for the first UE, on a first resource block, DMRS may not be associated with the data, and the first modulation symbol may be spread using the RS sequence and mapped to the first set of REs associated with the first antenna port p₀ 606. On a second resource block, DMRS may be associated with the data, and a second RS comprising the RS sequence r(·) may be communicated on the first set of REs associated with the first antenna port p₀ 606 using at least one orthogonal cover code, instead of the first modulation symbol 604 being mapped to those REs. In such examples, on the second resource block, the first RS 603 associated with the co-scheduled UE and the second RS associated with the first UE may be orthogonal to one another based on the applied orthogonal cover codes.

In some examples, for the co-scheduled UE, on the first resource block, DMRS may be associated with the data, and the first RS 603 may be mapped to the first set of REs associated with the second antenna port p₁ 602. On the second resource block, DMRS associated with the data may not be communicated, and instead a fourth modulation symbol (not shown) may be spread using the RS sequence r(·) and at least one orthogonal cover code and communicated on the first set of REs. In such examples, on the second resource block, the RS-sequence-spread fourth modulation symbol associated with the co-scheduled UE and the RS-sequence-spread first modulation symbol associated with the first UE may be orthogonal to one another based on orthogonal cover code spreading.

In some examples, on the second resource block, for the first UE, a second RS comprising the RS sequence r(·) may be communicated on the first set of REs associated with the first antenna port p₀ 606 using at least one orthogonal cover code, instead of transmitting the first modulation symbol on those REs. In such examples, the RS-sequence-spread fourth modulation symbol associated with the co-scheduled UE and the second RS associated with the first UE may be orthogonal based on the applied orthogonal cover codes. In some examples, DMRS associated with data modulation symbols may be used to support demodulation and detection of the corresponding data modulation symbols at the receiving UE.

In this manner, orthogonal cover codes reserved for reference signals of co-scheduled UEs that are not present may be reused to multiplex data symbols, improving utilization of reference-signal resources.

In other examples, a first node may communicate a first modulation symbol and a second modulation symbol. The first modulation symbol may be mapped to a first set of resource elements on a first antenna port p₀, where the mapping includes spreading the first modulation symbol using a first set of RS sequence elements and at least one orthogonal cover code, such as a first frequency-domain orthogonal code and/or a first time-domain orthogonal code. The second modulation symbol may be mapped to a second resource element on the first antenna port p₀ without spreading using an RS sequence.

In some examples, the first node may also communicate a first reference signal, such as a DMRS, associated with the first modulation symbol and the second modulation symbol. The first reference signal sequence may be based on the first set of RS sequence elements and at least one orthogonal cover code, such as a second frequency-domain orthogonal code and/or a second time-domain orthogonal code, where the at least one of the first frequency-domain orthogonal code and the first time-domain orthogonal code is orthogonal to the corresponding at least one of the second frequency-domain orthogonal code and the second time-domain orthogonal code. The first reference signal sequence may be mapped to the first set of resource elements on a second antenna port p₁.

In some examples, communication of at least one of the first modulation symbol and the second modulation symbol may be configured such that a channel over which the at least one of the first modulation symbol and the second modulation symbol on the first antenna port p₀ is conveyed is inferred from a channel over which the first reference signal sequence on the second antenna port p₁ is conveyed. In some examples, when the first reference signal is not present on the first set of resource elements (e.g., in a first resource block and/or first slot comprising the first modulation symbol and/or the second modulation symbol), the first node may infer the channel based on a second reference signal sequence communicated on a different time-frequency resource, such as a second resource block and/or second slot, within a defined time-domain window and/or frequency-domain window. The second reference signal sequence may be communicated on the first antenna port p₀ or the second antenna port p₁. In another example, the second reference signal may correspond to a most recent communication occasion such as within a time-domain window duration prior to the communication of the first modulation symbol and/or the second modulation symbol.

In some examples, the first modulation symbol and the second modulation symbol may be modulation symbols of a first transmission layer associated with a first precoder, and the RS-sequence-spread first modulation symbol and the second modulation symbol may be precoded using the first precoder and mapped to the first set of resource elements and the second resource element on the first antenna port p₀, respectively. In other examples, the first modulation symbol may correspond to a first layer associated with a first precoder and mapped to the first antenna port p₀, while the second modulation symbol may correspond to a second layer associated with a second precoder and mapped to a second antenna port p₁. In some implementations, the second layer, the second precoder, and the second antenna port p₁ may be the same as the first layer, the first precoder, and the first antenna port p₀, respectively. In further examples, a portion of the data comprising RS-sequence-spread modulation symbols may be associated with a first set of layers having a first number of layers, while another portion of the data comprising modulation symbols not spread using an RS sequence may be associated with a second set of layers having a second number of layers, where the first and second sets of layers may be the same or different.

In some examples, the first antenna port p₀ and the second antenna port p₁ may be quasi co-located, such that large-scale channel properties inferred from the first reference signal sequence conveyed on the second antenna port p₁ are applicable to at least one of the first modulation symbol and the second modulation symbol conveyed on the first antenna port p₀. The large-scale channel properties may include one or more of delay spread, Doppler spread, Doppler shift, average gain, average delay, and spatial reception parameters. In other examples, the second antenna port p₁ may be the same as the first antenna port p₀, and the first reference signal sequence may be combined with the RS-sequence-spread first modulation symbol and mapped to the first set of resource elements on the first antenna port p₀.

In some examples, a size of the first set of RS sequence elements may be the same as a size of the first set of resource elements. In some examples, the first set of resource elements may be associated with a first CDM group. In further examples, the at least one of the first frequency-domain orthogonal code and the first time-domain orthogonal code, and the at least one of the second frequency-domain orthogonal code and the second time-domain orthogonal code, may be associated with the same CDM group.

In some examples, the first modulation symbol and the first reference signal may be communicated with a first transmit power, and the second modulation symbol may be communicated with a second transmit power, where the first transmit power may be the same as or different from the second transmit power. In some examples, a power of resource elements carrying the RS-sequence-spread first modulation symbol and a power of resource elements carrying the first reference signal may be the same. In other examples, a ratio between a power of resource elements carrying the RS-sequence-spread first modulation symbol and a power of resource elements carrying the first reference signal may differ from a ratio between a power of resource elements carrying the second modulation symbol and the power of resource elements carrying the first reference signal. In some examples, such ratios or at least one ratio value such as the second modulation symbol power ratio may be indicated to the first node, for example via DCI, and may further depend on a number of DMRS CDM groups without data that may be indicated to the first node, a number of spatial layers, and/or a number of antenna ports.

In some examples, the first node may receive an indication identifying the first set of resource elements and the at least one of the first frequency-domain orthogonal code and the first time-domain orthogonal code as being available for communicating the first modulation symbol, and in response to the indication, map the first modulation symbol to the first set of resource elements on the first antenna port p₀. In other examples, the first node may receive an indication that a DMRS intended for a third node that is co-scheduled with the first node is not present on the first set of resource elements, where such DMRS, if present, would have been associated with the at least one of the first frequency-domain orthogonal code and the first time-domain orthogonal code. In response, the first node may use the at least one of the first frequency-domain orthogonal code and the first time-domain orthogonal code to spread and communicate the first modulation symbol on the first antenna port p₀.

In some examples, the first node may receive an indication as to whether a first reference signal associated with at least the second modulation symbol is present on the first set of resource elements. In response to the first reference signal is present, the first reference signal sequence is based on the first set of RS sequence elements and at least one of the first frequency-domain orthogonal code and the first time-domain orthogonal code, and the first reference signal sequence is mapped to the first set of resource elements on the first antenna port. In response to the first reference signal associated is not present, the RS-sequence-spread first modulation symbol is mapped to the first set of resource elements on the first antenna port by spreading the first modulation symbol based on at least one of the first frequency-domain orthogonal code and the first time-domain orthogonal code and communicating on the first antenna port.

In some examples, the first node may receive an indication that a first reference signal associated with at least the second modulation symbol is not present on the first set of resource elements, and a second reference signal intended for a third node that is co-scheduled with the first node is present on the first set of resource elements. The first RS, if present, would have been associated with at least one of the first frequency-domain orthogonal code and the first time-domain orthogonal code. The second RS is associated with at least one of a second frequency-domain orthogonal code and a second time-domain orthogonal code on the first set of resource elements on a second antenna port. In response to receiving the indication, the RS-sequence-spread first modulation symbol is mapped to the first set of resource elements on the first antenna port by spreading the first modulation symbol based on at least one of the first frequency-domain orthogonal code and the first time-domain orthogonal code and communicating on the first antenna port. In a further example, the first node may communicate at least one of the first modulation symbol and the second modulation symbol such that a channel over which the at least one of the first modulation symbol and the second modulation symbol on the first antenna port is conveyed is inferred from a channel over which another RS on the first antenna port is conveyed if the another RS and the at least one of the first modulation symbol and the second modulation symbol is within a first time-domain window, and at least one of the first set of resource elements and second resource element, and resource elements associated with the another RS are within a first frequency-domain window.

In some examples, the first node may receive an indication that a first reference signal associated with at least the second modulation symbol is present on the first set of resource elements, and a second reference signal intended for a third node that is co-scheduled with the first node is not present on the first set of resource elements. The first RS is associated with at least one of a second frequency-domain orthogonal code and a second time-domain orthogonal code on the first set of resource elements on the first antenna port. The second RS if present, would have been associated with at least one of the first frequency-domain orthogonal code and the first time-domain orthogonal code. In response to receiving the indication, the RS-spreaded first modulation symbol is mapped to the first set of resource elements on the first antenna port by spreading the first modulation symbol based on at least one of the first frequency-domain orthogonal code and the first time-domain orthogonal code and communicating on the first antenna port.

In some examples, the first node may receive an indication as to whether DMRS resource elements are present on a given set of resource elements and, if present, whether the DMRS are zero-power or non-zero-power DMRS. In some examples, DMRS may be present on a subset of resource blocks or slots. In other examples, for multi-slot scheduling or transport block mapping across multiple slots, the first node may receive an indication identifying a subset of slots in which DMRS are present. On resource blocks or slots without DMRS, RS-sequence-spread modulation symbols may be communicated on DMRS resource elements, enabling multiplexing with DMRS of other co-scheduled nodes.

In some examples, the first node may expect to receive the indication or be configured to receive such indication described in the examples when a representation of the first node channel quality is above a threshold. In some examples, the first node may not be expected to receive an indication as described in the examples or an indication indicating a RS-sequence-spread first modulation symbol when a representation of the first node channel quality is below a threshold. In some examples, channel quality may comprise Signal-to-Noise ratio (SNR), Signal-to-Interference plus noise ratio (SINR), RSRP (Reference Signal Received Power), RSRQ (Reference Signal Received Quality), CQI (Channel Quality Index) value etc.

In some examples, the first set of resource elements may include resource elements that are adjacent or non-adjacent in one or both of a frequency domain and a time domain. In some examples, the first set of resource elements may span one or more OFDM symbols, and the second resource element may be located on an OFDM symbol different from those of the first set of resource elements.

In some examples, a DMRS configuration may indicate a fraction of symbols and/or resource elements of a time-frequency resource grid that may be occupied by DMRS. Different DMRS configurations may correspond to different fractions of symbols and resource elements. In some examples, the DMRS configuration may be determined based on measurements derived from CSI-RS and/or SRS.

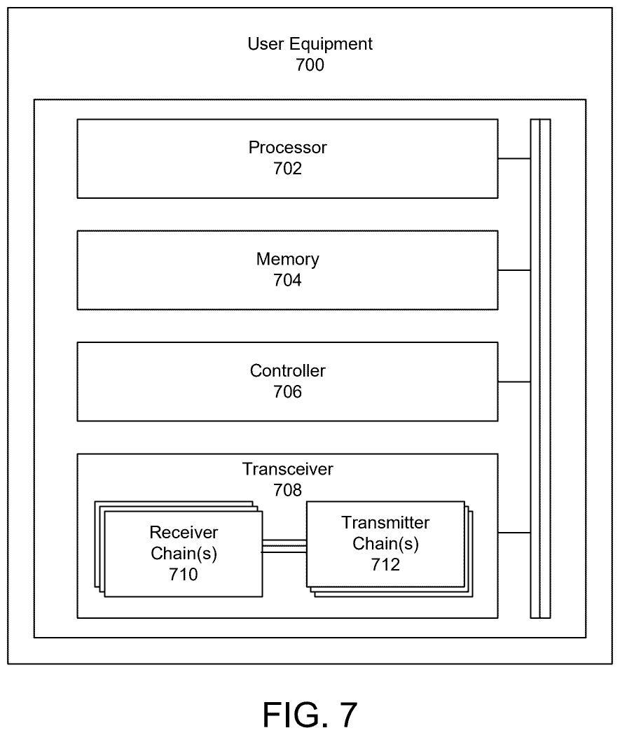

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the UE functions described herein (e.g., executing, by the processor 702, instructions stored in the memory 704). Accordingly, the processor 702 may support wireless communication at the UE 700 in accordance with examples as disclosed herein.

In one example, the UE 700 is configured to receive a downlink signal comprising reference-signal resources associated with a reference signal sequence, process, on at least a portion of the reference-signal resources, at least one information-bearing symbol that is spread using the reference signal sequence and an orthogonal cover code, and recover data based on the at least one information-bearing symbol associated with the reference signal sequence and the orthogonal cover code.

In one example, the orthogonal cover code is applied in at least one of a frequency domain or a time domain. In one example, the at least one information-bearing symbol is spread using the reference signal sequence identical to a sequence used for demodulation reference signal. In one example, the downlink signal includes a reference signal that is received on the reference-signal resources with the reference signal spread using the reference signal sequence and a first orthogonal cover code, and the at least one information-bearing symbol is received on the reference-signal resources using a second orthogonal cover code, the first orthogonal cover code orthogonal to the second orthogonal cover code.

In one example, the UE 700 is configured to recover the data by de-spreading the information-bearing symbols using the reference signal sequence and the orthogonal cover code. In one example, the downlink signal is associated with a MIMO transmission, and wherein the at least one information-bearing symbol is transmitted on the reference-signal resources using a first orthogonal cover code and an associated first transmission layer, and a reference signal is transmitted on the reference-signal resources with the reference signal spread using the reference signal sequence and a second orthogonal cover code and associated with a second transmission layer, the first orthogonal cover code orthogonal to the second orthogonal cover code.

In one example, the reference-signal resources are shared between the UE 700 and a co-scheduled UE, and the at least one information-bearing symbol of the UE 700 using a first orthogonal cover code is orthogonal to reference signal of the co-scheduled UE that is spread using the reference signal sequence and a second orthogonal cover code on the reference-signal resources, wherein the first orthogonal cover code is different than the second orthogonal cover code.

In one example, the UE 700 is configured to receive an indication in a downlink control channel that a reference signal intended for a co-scheduled UE is present on the reference-signal resources and a reference signal of the UE is not present on the reference-signal resources, and process, on at least a portion of the reference-signal resources, the at least one information-bearing symbol of the UE in response to receiving the indication.

In one example, the UE 700 is configured to perform demodulation based on reference signal received on at least a subset of the reference-signal resources. In one example, the subset of reference-signal resources varies across resource blocks. In one example, the downlink signal includes a second information-bearing symbol transmitted on a resource other than the reference-signal resources.

In one example, the at least one information-bearing symbol is transmitted with a first transmit power, the second information-bearing symbol is transmitted with a second transmit power, and a ratio of the at least one information-bearing symbol resource element power to a reference signal resource element power is a first value, and a ratio of the second information-bearing symbol resource element power to the reference signal resource element power is a second value.

In one example, the UE 700 is configured to receive an indication in a downlink control channel that the reference-signal resources and the orthogonal cover code is used for transmitting the at least one information-bearing symbol, and process, on at least a portion of the reference-signal resources, the at least one information-bearing symbol in response to receiving the indication.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

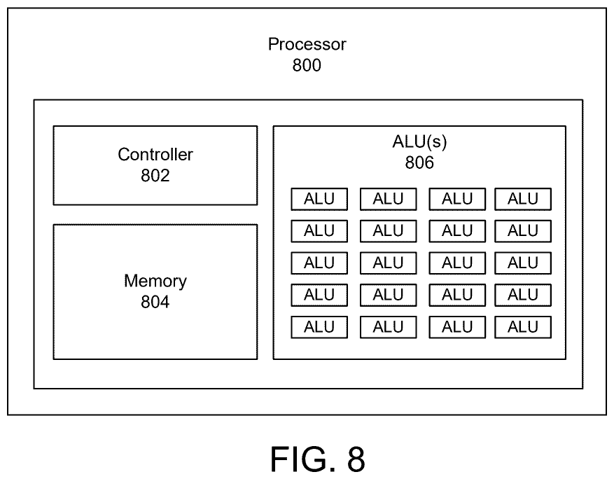

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In various examples, the processor 800 may support wireless communication of a UE, in accordance with examples as disclosed herein. In other examples, the processor 800 may support wireless communication of a RAN entity, in accordance with examples as disclosed herein.

In one example, the processor 800 is configured to receive a downlink signal comprising reference-signal resources associated with a reference signal sequence, process, on at least a portion of the reference-signal resources, at least one information-bearing symbol that is spread using the reference signal sequence and an orthogonal cover code, and recover data based on the at least one information-bearing symbol based on the reference signal sequence and the orthogonal cover code.

In one example, the orthogonal cover code is applied in at least one of a frequency domain or a time domain. In one example, the at least one information-bearing symbol is spread using the reference signal sequence identical to a sequence used for demodulation reference signal. In one example, the downlink signal includes a reference signal that is received on the reference-signal resources with the reference signal spread using the reference signal sequence and a first orthogonal cover code, and the at least one information-bearing symbol is received on the reference-signal resources using a second orthogonal cover code, the first orthogonal cover code orthogonal to the second orthogonal cover code.

In one example, the processor 800 is configured to recover the data by de-spreading the information-bearing symbols using the reference signal sequence and the orthogonal cover code. In one example, the downlink signal is associated with a MIMO transmission, and wherein the at least one information-bearing symbol is transmitted on the reference-signal resources using a first orthogonal cover code and an associated first transmission layer, and a reference signal is transmitted on the reference-signal resources with the reference signal spread using the reference signal sequence and a second orthogonal cover code and associated with a second transmission layer, the first orthogonal cover code orthogonal to the second orthogonal cover code.

In one example, the reference-signal resources are shared between the UE and a co-scheduled UE, and the at least one information-bearing symbol of the UE using a first orthogonal cover code is orthogonal to reference signal of the co-scheduled UE that is spread using the reference signal sequence and a second orthogonal cover code on the reference-signal resources, wherein the first orthogonal cover code is different than the second orthogonal cover code.

In one example, the processor 800 is configured to receive an indication in a downlink control channel that a reference signal intended for a co-scheduled UE is present on the reference-signal resources and a reference signal of the UE is not present on the reference-signal resources, and process, on at least a portion of the reference-signal resources, the at least one information-bearing symbol of the UE in response to receiving the indication.

In one example, the processor 800 is configured to perform demodulation based on reference signal received on at least a subset of the reference-signal resources. In one example, the subset of reference-signal resources varies across resource blocks. In one example, the downlink signal includes a second information-bearing symbol transmitted on a resource other than the reference-signal resources.

In one example, the at least one information-bearing symbol is transmitted with a first transmit power, the second information-bearing symbol is transmitted with a second transmit power, and a ratio of the at least one information-bearing symbol resource element power to a reference signal resource element power is a first value, and a ratio of the second information-bearing symbol resource element power to the reference signal resource element power is a second value.

In one example, the processor 800 is configured to receive an indication in a downlink control channel that the reference-signal resources and the orthogonal cover code is used for transmitting the at least one information-bearing symbol, and process, on at least a portion of the reference-signal resources, the at least one information-bearing symbol in response to receiving the indication.

In one example, the processor 800 is configured to generate a downlink signal including reference-signal resources associated with a reference signal sequence, map information-bearing symbols onto at least a portion of the reference-signal resources by spreading the information-bearing symbols using the reference signal sequence and an orthogonal cover code, and transmit the downlink signal to a UE.

In one example, the reference-signal resources include DMRS resources. In one example, the orthogonal cover code is applied in at least one of a frequency domain or a time domain. In one example, the downlink signal is associated with a MIMO transmission, and the information-bearing symbols are mapped to reference-signal resources of a first transmission layer. In one example, the reference-signal resources are shared between a plurality of UE, and the information-bearing symbols are transmitted orthogonally to reference symbols of at least one other user equipment based on different orthogonal cover codes.

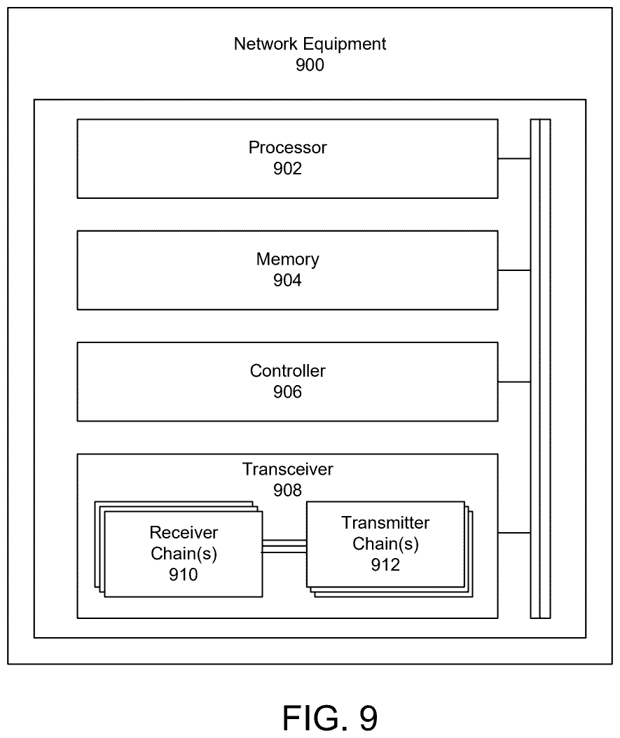

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the RAN functions described herein (e.g., executing, by the processor 902, instructions stored in the memory 904). For example, the processor 902 may support wireless communication at the NE 900 in accordance with examples as disclosed herein.

In one example, the NE 900 is configured to generate a downlink signal including reference-signal resources associated with a reference signal sequence, map information-bearing symbols onto at least a portion of the reference-signal resources by spreading the information-bearing symbols using the reference signal sequence and an orthogonal cover code, and transmit the downlink signal to a UE.

In one example, the reference-signal resources include DMRS resources. In one example, the orthogonal cover code is applied in at least one of a frequency domain or a time domain. In one example, the downlink signal is associated with a MIMO transmission, and the information-bearing symbols are mapped to reference-signal resources of a first transmission layer. In one example, the reference-signal resources are shared between a plurality of UE, and the information-bearing symbols are transmitted orthogonally to reference symbols of at least one other user equipment based on different orthogonal cover codes.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

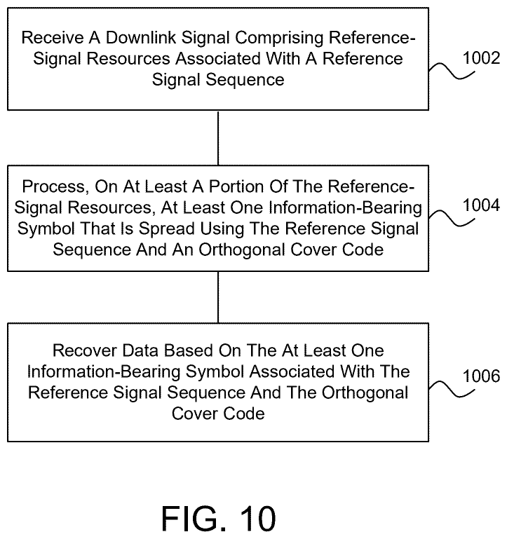

FIG. 10 illustrates a flowchart of a method performed by a UE 700 in accordance with aspects of the present disclosure. The operations of the method may be implemented by a UE 700 as described herein. In some implementations, the UE 700 may execute a set of instructions to control the function elements of the UE 700 to perform the described functions.

At step 1002, the method may receive a downlink signal comprising reference-signal resources associated with a reference signal sequence. The operations of step 1002 may be performed in accordance with examples as described herein. In some implementations, aspects of the operations of step 1002 may be performed by a UE 700, as described with reference to FIG. 7.

At step 1004, the method may process, on at least a portion of the reference-signal resources, at least one information-bearing symbol that is spread using the reference signal sequence and an orthogonal cover code. The operations of step 1004 may be performed in accordance with examples as described herein. In some implementations, aspects of the operations of step 1004 may be performed by a UE 700, as described with reference to FIG. 7.

At step 1006, the method may recover data based on the at least one information-bearing symbol associated with the reference signal sequence and the orthogonal cover code. The operations of step 1006 may be performed in accordance with examples as described herein. In some implementations, aspects of the operations of step 1006 may be performed by a UE 700, as described with reference to FIG. 7.

It should be noted that the method described herein describes one possible implementation, and that the operations and the steps may be rearranged or otherwise modified and that other implementations are possible.

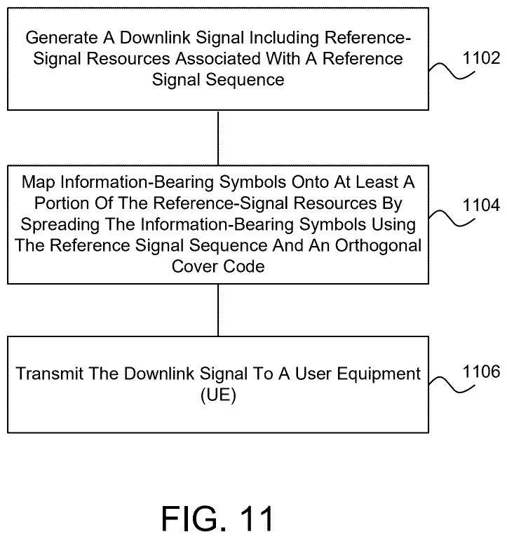

FIG. 11 illustrates a flowchart of a method performed by an NE 900 in accordance with aspects of the present disclosure. The operations of the method may be implemented by an NE 900 as described herein. In some implementations, the NE 900 may execute a set of instructions to control the function elements of the NE 900 to perform the described functions.

At step 1102, the method may generate a downlink signal including reference-signal resources associated with a reference signal sequence. The operations of step 1102 may be performed in accordance with examples as described herein. In some implementations, aspects of the operations of step 1102 may be performed by an NE 900, as described with reference to FIG. 9.

At step 1104, the method may map information-bearing symbols onto at least a portion of the reference-signal resources by spreading the information-bearing symbols using the reference signal sequence and an orthogonal cover code. The operations of step 1104 may be performed in accordance with examples as described herein. In some implementations, aspects of the operations of step 1104 may be performed by an NE 900, as described with reference to FIG. 9.

At step 1106, the method may transmit the downlink signal to a UE. The operations of step 1106 may be performed in accordance with examples as described herein. In some implementations, aspects of the operations of step 1106 may be performed by an NE 900, as described with reference to FIG. 5.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a downlink signal comprising reference-signal resources associated with a reference signal sequence;
process, on at least a portion of the reference-signal resources, at least one information-bearing symbol that is spread using the reference signal sequence and an orthogonal cover code; and
recover data based on the at least one information-bearing symbol associated with the reference signal sequence and the orthogonal cover code.

2. The UE of claim 1, wherein the orthogonal cover code is applied in at least one of a frequency domain or a time domain.

3. The UE of claim 1, wherein the at least one information-bearing symbol is spread using the reference signal sequence identical to a sequence used for demodulation reference signal.

4. The UE of claim 1, wherein the downlink signal comprises a reference signal that is received on the reference-signal resources with the reference signal spread using the reference signal sequence and a first orthogonal cover code, and the at least one information-bearing symbol is received on the reference-signal resources using a second orthogonal cover code, the first orthogonal cover code orthogonal to the second orthogonal cover code.

5. The UE of claim 1, wherein the at least one processor is configured to cause the UE to recover the data by de-spreading the information-bearing symbols using the reference signal sequence and the orthogonal cover code.

6. The UE of claim 1, wherein the downlink signal is associated with a multiple-input multiple-output (MIMO) transmission, and wherein the at least one information-bearing symbol is transmitted on the reference-signal resources using a first orthogonal cover code and an associated first transmission layer, and a reference signal is transmitted on the reference-signal resources with the reference signal spread using the reference signal sequence and a second orthogonal cover code and associated with a second transmission layer, the first orthogonal cover code orthogonal to the second orthogonal cover code.

7. The UE of claim 1, wherein the reference-signal resources are shared between the UE and a co-scheduled UE, and the at least one information-bearing symbol of the UE using a first orthogonal cover code is orthogonal to reference signal of the co-scheduled UE that is spread using the reference signal sequence and a second orthogonal cover code on the reference-signal resources, wherein the first orthogonal cover code is different than the second orthogonal cover code.

8. The UE of claim 7, wherein the at least one processor is configured to cause the UE to receive an indication in a downlink control channel that a reference signal intended for a co-scheduled UE is present on the reference-signal resources and a reference signal of the UE is not present on the reference-signal resources, and process, on at least a portion of the reference-signal resources, the at least one information-bearing symbol of the UE in response to receiving the indication.

9. The UE of claim 1, wherein the at least one processor is configured to cause the UE to perform demodulation based on reference signal received on at least a subset of the reference-signal resources.

10. The UE of claim 9, wherein the subset of reference-signal resources varies across resource blocks.

11. The UE of claim 1, wherein the downlink signal comprises a second information-bearing symbol transmitted on a resource other than the reference-signal resources.

12. The UE of claim 11, wherein the at least one information-bearing symbol is transmitted with a first transmit power, the second information-bearing symbol is transmitted with a second transmit power, and a ratio of the at least one information-bearing symbol resource element power to a reference signal resource element power is a first value, and a ratio of the second information-bearing symbol resource element power to the reference signal resource element power is a second value.

13. The UE of claim 1, wherein the at least one processor is configured to cause the UE to receive an indication in a downlink control channel that the reference-signal resources and the orthogonal cover code is used for transmitting the at least one information-bearing symbol, and process, on at least a portion of the reference-signal resources, the at least one information-bearing symbol in response to receiving the indication.

14. A method of a user equipment (UE), comprising:
receiving a downlink signal comprising reference-signal resources associated with a reference signal sequence;
processing, on at least a portion of the reference-signal resources, at least one information-bearing symbol that is spread using the reference signal sequence and an orthogonal cover code; and
recovering data based on the at least one information-bearing symbol associated with the reference signal sequence and the orthogonal cover code.

15. A network equipment (NE) for wireless communication, comprising:
at least one memory; and
at least one processor coupled with the at least one memory and configured to cause the NE to:
generate a downlink signal including reference-signal resources associated with a reference signal sequence;
map information-bearing symbols onto at least a portion of the reference-signal resources by spreading the information-bearing symbols using the reference signal sequence and an orthogonal cover code; and
transmit the downlink signal to a user equipment (UE).

16. The NE of claim 15, wherein the reference-signal resources comprise demodulation reference signal (DMRS) resources.

17. The NE of claim 15, wherein the orthogonal cover code is applied in at least one of a frequency domain or a time domain.

18. The NE of claim 15, wherein the downlink signal is associated with a multiple-input multiple-output (MIMO) transmission, and the information-bearing symbols are mapped to reference-signal resources of a first transmission layer.

19. The NE of claim 15, wherein the reference-signal resources are shared between a plurality of UE, and the information-bearing symbols are transmitted orthogonally to reference symbols of at least one other user equipment based on different orthogonal cover codes.

20. A method of a network equipment (NE), comprising:
generating a downlink signal including reference-signal resources associated with a reference signal sequence;
mapping information-bearing symbols onto at least a portion of the reference-signal resources by spreading the information-bearing symbols using the reference signal sequence and an orthogonal cover code; and
transmitting the downlink signal to a user equipment (UE).
